(19) United States
(12) Patent Application Publication
(10) Pub. No.: US 2015/0213712 A1
(43) Pub. Date: Jul. 30, 2015

(54) DETECTING TRAFFIC AND ACCIDENT DATA AT ROAD JUNCTIONS

(71) Applicant: AUDI AG, Ingolstadt (DE)

(72) Inventor: Michael Keller, Ingolstadt (DE)

(73) Assignee: AUDI AG, Ingolstadt (DE)

(21) Appl. No.: 14/420,228

(22) PCT Filed: Sep. 11, 2013
(86) PCT No.: PCT/EP2013/002721

§ 371 Date: Feb. 6, 2015

(30) Foreign Application Priority Data
Sep. 14, 2012 (DE) 10 2012 018 212.0

(51) Int. Cl. G08G 1/017

(52) U.S. Cl. CPC G08G 1/017

(57) ABSTRACT

In a method for detecting traffic and/or accident data at a road junction by means of a vehicle which has a control unit which is coupled to at least one sensor of the vehicle, in a first step, the sensor detects traffic crossing the vehicle; and in a second step, the data which represents the crossing traffic is transmitted from the control unit of the vehicle to at least one receiver external to the vehicle. The method for detecting traffic and accident data at road junctions represents a significant improvement for avoiding accidents and/or traffic congestions.

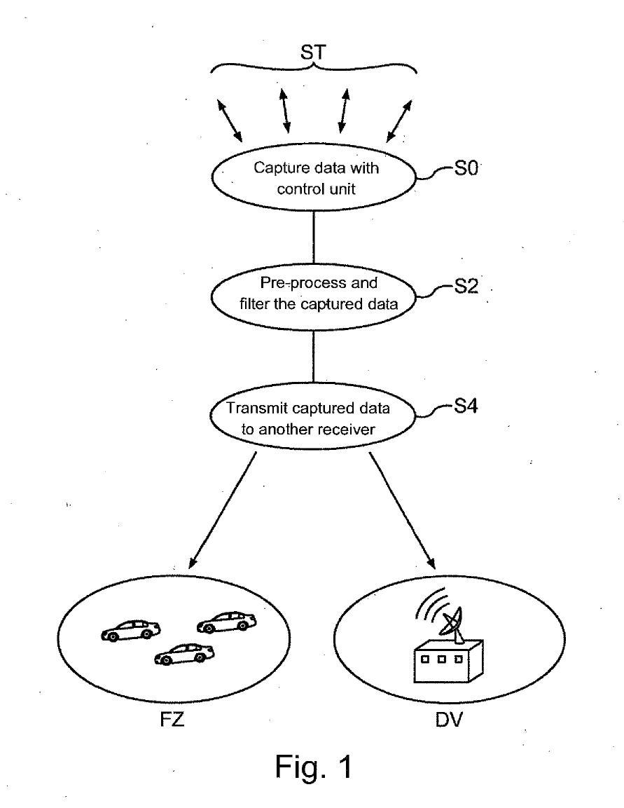

The invention relates to a method for detecting traffic and/or accident data at junctions in road traffic as well as a device for detecting these traffic data and/or accident data using the method.

To evaluate an existing traffic infrastructure and to schedule new efficient traffic routes, large expenses are incurred for determining the utilization of the traffic routes. With new navigation and route planning systems that communicate with databases, both the individual participation in traffic can be planned as well as an entire traffic network can be monitored and coordinated from a central monitoring facility. Efficient planning requires reliable and timely data about the roads and road junctions in road traffic. By using the collected data, traffic congestion, a traffic shift or a detour can then be effectively and reliably designed.

Different acquisition devices and detection methods are presently used for obtaining reliable data for studying traffic flows in a defined traffic space by traffic analysis and traffic surveys, such as traffic lights with induction loops or sensors installed in traffic control systems for counting the moving vehicles, especially motor vehicles.

In addition, information regarding dangerous junctions in road traffic, such as intersections, highway ramps or road junctions is of particular interest because traffic accidents have an immediate negative impact on the traffic flow. Currently, dangerous junctions in road traffic are recorded only by certain institutions, such as the local police department, GIDAS or the Audi Accident Research Unit.

Accidents are recorded in most cases only in the event of a personal injury. When property damage occurs, such accidents are usually recorded only with the insurance companies. In addition, there is no link between the different institutions and their data, which significantly complicates the analysis with respect to reliable information and forecasts of an emerging traffic pattern, because the captured or collected data are also registered with a time delay. Therefore, especially data concerning traffic flows at uncontrolled junctions in road traffic are of great interest, for example, at intersections or merging roads having a traffic volume that cannot be detected with traffic lights.

It is an object of the present invention to provide a method for detecting traffic and/or accident data and a device for using the method, whereby timely and reliable traffic data can be detected and evaluated with the method.

This object is attained with a method for detecting the traffic and/or accident data at a junction in road traffic by a vehicle having a control unit that is coupled with at least one sensor of the vehicle, wherein:

in a first step, traffic moving across the vehicle is detected with the sensor; and
in a second step, the data representative of the cross-traffic are transmitted by the control unit of the vehicle to at least one receiver that is external with respect to the vehicle.

A major advantage of the method lies in its independence of infrastructural detection sensors, as is the case for example with controlled junctions having traffic lights. Furthermore, no other persons/technical resources are needed to capture the traffic situation. Moreover, even critical situations without collisions can be detected, minor damages that were not recorded by the police, but which are an indication of problematic junctions in road traffic.

Thus, movement data of other traffic can be captured in addition to their own movement data. The collected data can be transmitted to a receiver external to the vehicle unchanged, i.e. as raw data.

In a particularly preferred embodiment of the invention, the data representing the cross traffic are pre-processed by the control unit of the vehicle. The control unit of the vehicle has filters that perform a kind of pre-selection prior to transmission of the data representative of the crossing road traffic, whereby only those data are transmitted to the external receiver that represent a significant intervention in the traffic. This relieves the transmission networks and shields the receiver from superfluous “data trash”.

Advantageously, the pre-processed data represent at least a point in time and/or duration and/or location coordinates and/or a number of road users crossing the vehicle. Based on these data, inferences can be easily made on the traffic flow and/or events having a negative impact. Especially valuable is information relating to dangerous road junctions, such as intersections, highway ramps and road junctions. A problematic junction in road traffic can be readily located by way of the detected position coordinates; peak or periods of low traffic volumes can be easily identified by way of the time; duration and number of road users crossing the vehicle provide insight into possible traffic congestion or a smooth traffic flow.

According to another particularly advantageous embodiment, the pre-processed data include information relating to an activation state of a driver assistance system of the vehicle. If a critical situation exists at the respective junction in road traffic when the driver has activated his driver assistance system, a dangerous junction in the road traffic can be inferred, because the driver gets into a dangerous situation in spite of the active driver assistance system. This information is particularly valuable when the evaluated data are introduced into a navigation system or route planning software, because a driver assistance system in the vehicle can then be operated automatically or the driver may be prompted to turn the driver assistance system on when approaching the dangerous junction in road traffic. As a result, accidents can be anticipated and traffic congestion can be avoided. Furthermore, these data are also highly useful in the planning of roads and traffic networks.

It is particularly useful when the at least one receiver external to the vehicle, to which the pre-processed data are transmitted, includes a control unit of another vehicle and/or central processing location. If one or more vehicles are recipients of the pre-processed data, then these vehicles can be made aware of the danger zone or a “sluggish” traffic based on the received information and respond intelligently either individually or as a “swarm”.

Furthermore, the pre-processed data that were transmitted to a central data processing facility can be used by this central data processing facility in a particularly useful way. On the one hand, other vehicles located in the vicinity of the registered location coordinates of can be directly informed of the traffic flow and, on the other hand, a “history” of the traffic flow at the particular location coordinates or junctions in the road traffic may be created in the long run. In this way, data collected by the vehicle can be particularly easily statistically processed and used effectively in the planning of routes. Furthermore, the data can also be incorporated into the programming of conventional navigation devices.

According to another aspect of the invention, a device for detecting traffic and/or accident data at a junction in road traffic by using a vehicle includes a control unit which can be coupled with at least one sensor of the vehicle, wherein the sensor is configured to detect traffic crossing the vehicle, and wherein data of the traffic crossing the vehicle can be transmitted by the control unit to at least one receiver external to the vehicle for processing. Vehicles that are equipped with such a device greatly facilitate the collection of traffic data, in particular at uncontrolled junctions in road traffic. A particularly effective and inexpensive device is thus provided, with which each vehicle can be equipped, to provide data that allow a particularly reliable statistical inference about the traffic flow, especially at uncontrolled junctions in road traffic.

A cost-effective and space-saving solution in accordance with an embodiment of the invention includes at least one photo sensor and/or infrared sensor and/or radar sensor and/or laser sensor and/or acoustic sensor. Particularly advantageous are sensors capable of identifying road users crossing the vehicle even under poor visibility or light conditions. In this way, even junctions that are difficult to see in traffic can be included in a data analysis.

The invention and exemplary embodiments will now be illustrated with reference to a drawing.

The sole FIGURE shows in form of a flow chart a possible technical implementation of the method for detecting traffic data and crash data at junctions in road traffic according to an embodiment of the invention.

Advantageously, the vehicles are equipped with sensors ST capable of detecting traffic crossing the vehicle. To ensure that traffic can be correctly detected even under road conditions that are difficult to see or access, the vehicles are according to a particularly advantageous embodiment equipped with different types of sensors ST. These can include at least a photo sensor and/or an infrared sensor and/or a radar sensor and/or a laser sensor and/or an acoustic sensor. Depending on the combination of these sensors ST, the crossing traffic can be detected independent of weather and light conditions.

The term “traffic crossing the vehicle” refers to traffic that moves past a vehicle in front of the vehicle equipped with the sensors ST, wherein the crossing traffic intersects with the direction of travel of the vehicle equipped with the sensors ST.

Accordingly, the sensors ST are connected to a control unit of the vehicle that captures data representing the crossing traffic.

In a first step S0, the data representing the traffic crossing the vehicle are captured by the control unit. These include data about a capture time, location coordinates, a number of road users crossing the vehicle as well as a duration, for example the required wait time, from which relevant information about the traffic flow or an accident event can be derived.

In a further step S4, the data acquired by the control device are transferred to another receiver FZ, DV external to the vehicle. In the particularly preferred embodiment of the invention illustrated in the FIGURE, the data captured by the control device are pre-processed S2 and filtered before transmission S4 to the other receiver FZ, DV. An emerging data traffic between the control unit of the vehicle and external receiver FZ, DV can be minimized by pre-assigning a possible accident, traffic congestion, obstructing traffic, high traffic volume or low traffic volume. For this purpose, the control device is provided with correspondingly suitable filtering software capable of differentiating between the exceptionally long wait times, heavy traffic due to the detected number of road users, etc.

In another particularly preferred embodiment, in addition to the traffic-related data of the crossing traffic, relevant operating data of the vehicle equipped with the sensors are also recorded and transmitted to the other receivers FZ, DV. These conditions may also give insight into an activated driver assistance system as well as acceleration and/or velocity values. In conjunction with vehicle-relevant operating parameters, for example, a reaction by the driver deviating from a normal reaction may be inferred, indicating a higher risk of an accident.

In one particular embodiment, the receiver FZ, DV external to the vehicle may be, for example, one or more vehicles FZ located within a certain distance from the vehicle capturing the data. These other vehicles FZ may be alerted to a possible congestion or dangerous road sections by capturing the current traffic situation using the vehicle provided with sensors ST at a particular junction in road traffic and by transmitting S4 this information to other vehicles FZ.

In an additional unillustrated embodiment, the receiver FZ, DV of the data is designed to communicate with other vehicles FZ and to bypass the junction in the road traffic due to a “swarm-intelligent” process, introducing also a possible diversion of other vehicles FZ.

In a particularly advantageous embodiment, the data transmitted from the vehicle equipped with sensors are forwarded exclusively or additionally to a central data processing facility DV.

By processing the data from at least one vehicle equipped with such sensors ST in a central data processing facility DV, an entire “history” of the traffic volume at a corresponding junction in the road traffic can be recorded. Meaningful statistical analyses can be performed by linking different data sets from different vehicles equipped with such sensors ST, which find a particular application when planning a route or assessing of traffic networks. This allows vehicles FZ equipped with corresponding devices for receiving data to be notified of dangerous junctions in road traffic or to be made aware of accidents. For example, a potential danger zone can be indicated to the driver of such vehicle before reaching the junction. Moreover, driver assistance systems can be automatically activated. The driver and/or his navigation system can actively support route planning by displaying any stopping times and emerging crossing traffic. In addition, various fluctuations in the traffic flow related to the time of day as well as a potential risk for congestion or an accident depending on a time and a location can be precisely identified. This can minimize stopping times and efficiently increase the traffic flow.

The method for detection of traffic data and/or accident data at junctions in road traffic represents not only a significant improvement in preventing accidents and/or the risk of congestion, but also makes a significant contribution to the economy.

1.-8. (canceled)

9. A method for capturing at least one of traffic data and accident data at a junction in road traffic by using a vehicle having a control unit which is coupled to at least one sensor of the vehicle, the method comprising:
capturing with the sensor crossing traffic moving across the vehicle; and
transmitting with the control unit of the vehicle data representing the crossing traffic to at least one receiver external to the vehicle, wherein the external receiver comprises a central data processing facility; and
statistically analyzing the transmitted data in the data processing facility so as to form a history of a traffic flow at the junction.

10. The method of claim 9, further comprising, before transmitting the data, pre-processing the data representing the crossing traffic with the control unit of the vehicle.

11. The method of claim 10, wherein the pre-processed data represent at least one of a time, a duration, location coordinates and a number of road users crossing the vehicle.

12. The method of claim 10, wherein the pre-processed data comprise information about a state of activation of a driver assistance system of the vehicle.

13. The method according to claim 12, wherein the data evaluated by the receiver form a basis for navigation planning and route planning.

14. A device for capturing at least one of traffic data and accident data at a junction in road traffic by using a vehicle, wherein the vehicle comprises
at least one sensor coupled with the control unit and configured to detect traffic crossing the vehicle, and
a control unit configured to transmit data of traffic crossing the vehicle from the control unit to at least one receiver external to the vehicle for processing, wherein the external receiver comprises a central data processing facility, with the data processing facility being configured to statistically evaluate the transmitted data to form a history of a traffic volume at the junction.

15. The device of claim 14, wherein the external receiver comprises a control unit of another vehicle.

16. The device of claim 15, wherein the at least one sensor (ST) is a photographic sensor and/or an infrared sensor and/or a radar sensor and/or a laser sensor and/or an acoustic sensor.
